(19) United States
(12) Patent Application Publication
(10) Pub. No.: US 2026/0196122 A1
(43) Pub. Date: Jul. 9, 2026

(54) EFFICIENCY CALCULATION FOR GATE AUTOMATION SYSTEM

(71) Applicant: ASSA ABLOY Entrance Systems AB, Landskrona (SE)

(72) Inventors: Vickie LENTS, Winston-Salem, NC (US); David P. BRESSON, Pfafftown, NC (US); Davide BRAGGION, Milan (IT); Pasquale DI LORENZO, Milan (IT)

(21) Appl. No.: 19/014,811

(22) Filed: Jan. 9, 2025

(51) Int. Cl. G08B 21/18; E05F 15/668

(52) U.S. Cl. CPC G08B 21/18; E05F 15/668; E05Y 2400/512; E05Y 2900/106

(57) ABSTRACT

A system for automated operation of a movable barrier includes a controller, an operator operable under control of the controller where the operator is operably coupled to the movable barrier to transition the movable barrier between an open position and a closed position responsive to operation of the operator, and an efficiency monitoring module including processing circuitry configured to receive current draw data associated with current draw of the operator while transitioning the movable barrier between the open position and the closed position, compare the received current draw data to reference current draw data to determine an efficiency rating for the operator, compare the determined efficiency rating to a threshold efficiency rating for a device class to which the operator belongs, and initiate a notification in response to the determined efficiency rating being below the threshold efficiency rating.

### TECHNICAL FIELD

Example embodiments generally relate to movable barriers or boundary elements such as doors, garage doors, gates, etc., and, in particular, relate to such a system that incorporates an ability to automatically determine the efficiency of system components for predictive maintenance and claims handling.

### BACKGROUND

Moveable sectional doors, such as garage doors, are commonly used to partition or enclose spaces. Just as commonly, an automated opening device is connected to the sectional doors in order to easily open or close the doors. As an example, a large portion of sectional doors for both residential and industrial applications employ an installed garage door opener (GDO) to automatically open and close the sectional doors. One solution for mounting and operating these GDOs is to mount the GDO from the ceiling proximate to the sectional door. For such ceiling mounted GDOs, a ceiling mounted linear force operator drags one of the connected sections of the sectional door through the guide rails the door rides in as the sectional door transitions between opened and closed positions. Other gates, doors, etc., that are movable to enable controlled access to spaces are often similarly moved via an automated opener such as a motor of some type.

A problem that can be encountered in the contexts above is that the movable barriers or boundary elements have components that can wear over time and may need replacement or maintenance. These problems can be exacerbated if, for example, an undersized motor or other operator is used for the weight of the movable barrier. Generally speaking, very little if any data is collected on the operator in systems including movable barriers. Instead, a typical solution is to only count the number of cycles of the operator and use the passage of a threshold number of cycles as a trigger to identify situations where maintenance is needed. However, this rudimentary form of monitoring ignores specific context information that can be really impactful in relation to determining actual needs for maintenance.

Accordingly, if certain data were to be collected and analyzed, the potential for identifying situations in which undersized or underpowered operators are being used and/or situations in which preventive/predictive maintenance should be performed may be identified and dealt with in an efficient manner. Example embodiments are aimed at collecting and analyzing data to enable efficiency calculations to be monitored in order to detect, and in some cases also automatically generate notifications, when certain undesirable situations are identified.

### BRIEF SUMMARY OF SOME EXAMPLES

In an example embodiment, a system for automated operation of a movable barrier is provided. The system may include a controller, an operator operable under control of the controller where the operator is operably coupled to the movable barrier to transition the movable barrier between an open position and a closed position responsive to operation of the operator, and an efficiency monitoring module including processing circuitry configured to receive current draw data associated with current draw of the operator while transitioning the movable barrier between the open position and the closed position, compare the received current draw data to reference current draw data to determine an efficiency rating for the operator, compare the determined efficiency rating to a threshold efficiency rating for a device class to which the operator belongs, and initiate a notification in response to the determined efficiency rating being below the threshold efficiency rating.

In another example embodiment, a method of evaluating performance of a movable barrier in an automated operating system may be provided. The method may include receiving current draw data associated with current draw of an operator that operates to transition the movable barrier between an open position and a closed position, comparing the received current draw data to reference current draw data to determine an efficiency rating for the operator, comparing the determined efficiency rating to a threshold efficiency rating for a device class to which the operator belongs, and initiating a notification in response to the determined efficiency rating being below the threshold efficiency rating.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a system for automated operation of a movable barrier in accordance with an example embodiment;

FIG. 2 illustrates a perspective view of a door opener system in a ceiling mounted or trolley configuration in accordance with an example embodiment;

FIG. 3 illustrates a block diagram of a door opener system having an efficiency monitoring module located at the opener of the system in accordance with an example embodiment;

FIG. 4 illustrates a block diagram of a door opener system having the efficiency monitoring module located remotely from the opener of the system in accordance with an example embodiment;

FIG. 5 illustrates a block diagram of a door opener system having the efficiency monitoring module located remotely from the opener of the system and wirelessly connected thereto in accordance with an example embodiment;

FIG. 6 illustrates a plot of current draw data to show phases of interest for efficiency determinations associated with determining system performance in accordance with an example embodiment;

FIG. 7 illustrates a lift gate system in accordance with an example embodiment;

FIG. 8 illustrates a sliding gate system according to an example embodiment;

FIG. 9 illustrates a method of determining motor/operator efficiency according to an example embodiment; and

FIG. 10 illustrates a user interface screen for notifying a user of various conditions relating to efficiency determined in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, movable barriers are typically monitored for maintenance purposes for little more than a number of cycles that an operator (e.g., a motor) that is used to drive automated opening thereof has performed. This leaves little chance to identify situation specific issues, and does not account for the actual situation or context of an individual movable barrier. Example embodiments provide a relatively simple monitoring method to be employed to enable operator efficiency to be determined. The efficiency determination can be used to monitor the actual performance of the operator and either recommend maintenance that appears to be advisable or identify situations where, for example, the operator is insufficiently powered or sized to operate a given movable barrier. This can be used, for example, to reject claims of defect when instead the operator was improperly setup or deployed. Other predictive/preventive maintenance opportunities may also be presented.

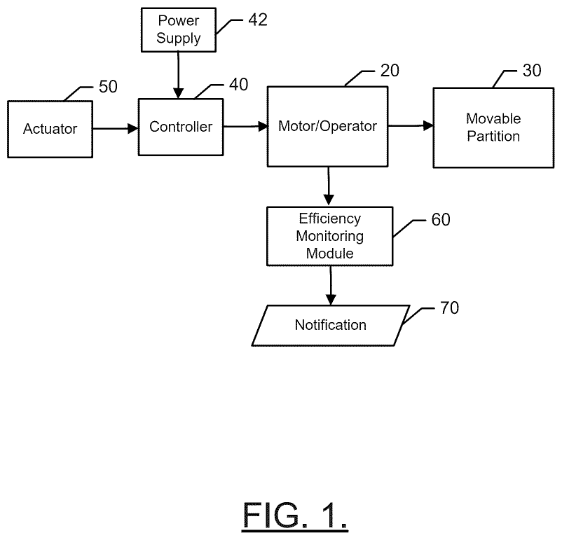

Example embodiments may apply to any type of movable barrier including, for example, doors or gates that either lift, swing, or slide under automated control. This includes sectional doors often used to control access to garages and other spaces. FIG. 1 illustrates a block diagram of a simple system 10 for automated operation of a movable barrier in which an example embodiment may be practiced. In this regard, for example, the system 10 may include a motor/operator 20 that is operably coupled to a movable barrier 30 to move the movable barrier between an open position in which access to a space that is temporarily enclosed via the movable barrier is possible and a closed position in which access to the space is prevented. The motor/operator 20 is operated under the control of a controller 40 that controls the provision of power to the motor/operator 20 from a power supply 42. The controller 40 may also include the logic, circuitry and/or application processing power for directing the responses to stimuli that initiate the transitions between the open and closed positions. Thus, for example, the controller 40 may be operably coupled (via wired or wireless connection) to an actuator 50, which may be actuated in order to trigger operation of the motor/operator 20 to transition the movable barrier 30 between the open and closed positions. When the trigger is received from the actuator 50, the controller 40 may provide power to the motor/operator 20 cause the motor/operator 20 to move the movable barrier 30 through an opening cycle, a closing cycle, or a full cycle that includes both opening and closing (or vice versa) depending on the arrangement and setup of the system 10.

As noted above, the number of cycles of the motor/operator 20 or the movable barrier 30 may typically be counted as the only criteria for determining when maintenance is due. However, example embodiments may add an efficiency monitoring module 60 that is operably coupled to the motor/operator 20 in order to monitor and/or measure a parameter that can be used as an indication of the efficiency of the motor/operator 20. The parameter that is measured may, in particular, be a parameter that is expected to change over time as wear, imbalance or other factors begin to develop. Moreover, even in set up, calibration, or a single cycle of transition of the movable barrier 30, the parameter may enable determinations to be made regarding whether the setup of the system 10 is at an acceptable level of efficiency.

In this regard, particularly in the context of a sectional door that is one example of the movable barrier 30, door imbalance or a mismatch between the power of the motor/operator 20 and the weight of the sectional door may be detectable by measuring efficiency as shown via the parameter of current drawn by the motor/operator 20 through a transition of the movable barrier 30 between the open position and the closed position. In this regard, for example, an unbalanced sectional door can be identified via a number of different physical manifestations or noticeable indicia. For example, if the sectional door makes strange or loud noises, or moves unevenly or at a slant when opening or closing, an unbalanced condition may exist. Alternatively, if the sectional door moves unusually slow, or fails to move at all, an unbalanced condition may exist. Whereas the user could certainly wait to notice one of these conditions, the fact of the matter is that once those conditions are noticed, the potential for component damage has already likely been in existence for some time. The motor, spring, rollers, cable, etc., may be damaged and may fail, which may render the door inoperable for a period of time until potentially expensive repairs can be conducted.

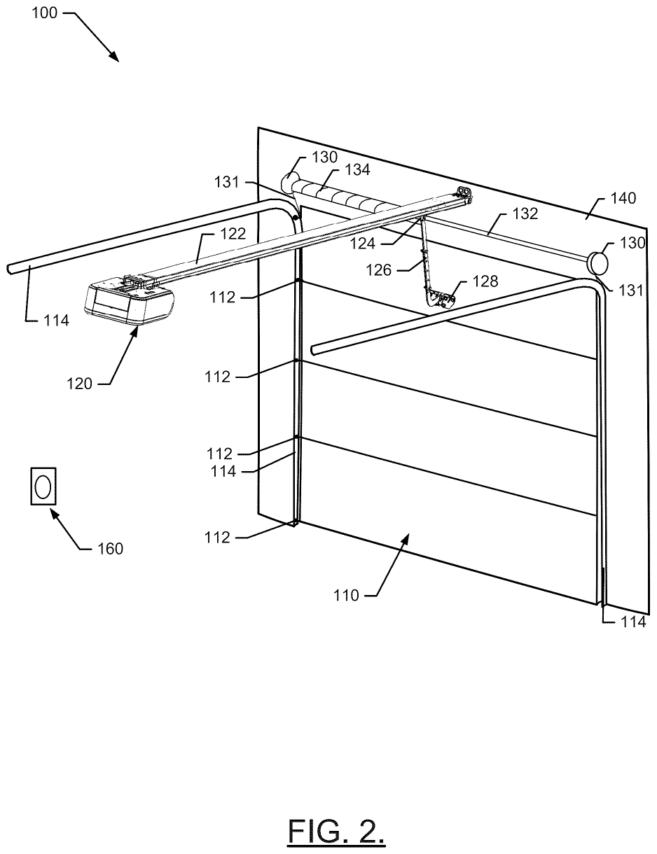

Accordingly, example embodiments aim to monitor current draw by the motor/operator 20 via the efficiency monitoring module 60 to calculate current efficiency and compare that efficiency to standards that can help identify situations where either maintenance is due or advisable or where the motor/operator 20 is not sufficiently powerful to move the movable barrier 30. Moreover, in some cases, example embodiments may further initiate a response to a determination of either of the situations above. More particularly, a notification 70 may be sent to the user, maintenance personnel, manufacturers, or any other desirable recipient. FIG. 2 illustrates one specific context in which example embodiments may be employed.

More particularly, FIG. 2 illustrates a garage door operator (GDO) system 100 of an example embodiment. In this regard, FIG. 1 shows the GDO system 100 in a trolley (or ceiling mounted) configuration, but it should be understood that example embodiments may also apply to situations in which the GDO system 100 is in a jackshaft configuration. In both cases, the GDO system 100 includes a sectional door 110 (an example of the movable barrier 30 of FIG. 1), in which each section of the door has rollers 112 operably coupled to opposing lateral sides of the sections. The rollers 112 are typically rotatably operably coupled to the sectional door 110 via brackets that rotatably support a shaft of the rollers 112 and enable a wheel to extend into and ride within rails 114 disposed on opposing sides of the sectional door 110 as the sectional door 110 transitions between open and closed positions. The sectional door 110 of FIG. 2 is shown in the closed position, where the rollers 112 are in a vertical section of the rails 114. Thus, it can be appreciated that in the open position the rollers 112 are located in a horizontally extending portion of the rails 114, and the sectional door 110 is carried into parallel with the ground as opposed to its condition of being perpendicular to the ground in the closed position shown in FIG. 2. Each section of the sectional door 110 can pivot relative to any adjacent section at an intersection thereof in order to enable the sectional door 110 to traverse the bend that separates the horizontally extending portion of the rails 114 from the vertically extending portion of the rails 114.

FIG. 2 also illustrates a GDO unit referred to as an opener 120 or motorhead, which includes the motor/operator 20 described above. The opener 120 of this example is shown in the trolley configuration in which a guide rail 122 may extend parallel to and approximately midway between the horizontally extending portion of the rails 114 on opposing lateral sides of the sectional door 110. The opener 120 may be mounted (e.g., from the ceiling) proximate to an end of the guide rail 122 to drive a trolley 124 along the guide rail 122 via a flexible member such as a belt, cable or chain. The belt, cable or chain may also be operably coupled (e.g., via the trolley 124) to a top portion of the sectional door 110 by an engaging arm 126 and engaging bracket 128 that is attached to the sectional door 110. As noted above, the trolley 124 may be manually released from the sectional door 110 to allow for manual repositioning of the sectional door 110.

In some cases, the sectional door 110 may also be supported by one or more instances of cables 131 that are alternately wound onto and off of one or more cable drums 130 disposed at or near opposing ends of a tube 132 (sometimes called a drive tube). The cables 131 may be attached to a bottom portion of the sectional door 110 to assist in carrying the weight of the sectional door 110. The tube 132 may further support a spring assembly 134 that facilitates, along with the cables 131, supporting the weight of the sectional door 110 during opening and closing operations of the sectional door 110 using the opener 120. The sectional door 110, when closed, may block an opening provided in a front wall 140 of the garage in which the GDO system 100 is installed. The opening may be left open when the sectional door 110 is raised onto the horizontally extending portions of the rails 114. As can be seen in FIG. 2, the guide rail 122 may be secured to the front wall 140 at a proximal end of the guide rail 122, and the opener 120 may be suspended from the ceiling of the garage at a distal end of the guide rail 122.

The sectional door 110 is, as noted above, often comprised of panels of aluminum, steel, fiberglass, plastic, or other relatively lightweight, but otherwise structurally rigid material of any suitable type. In some cases, one or more of the panels of the sectional door 110 may include or be comprised of a glass or film that may be transparent or translucent to allow natural light to pass therethrough and into the garage or other space to which the sectional door 110 provides access. The opener 120 draws power, typically from an alternating current (AC) mains power supply (an example of the power supply 42 of FIG. 1), which may be accessed by corded connection to a power supply outlet.

The opener 120 may be operable responsive to operation of a remote actuator 160, which may either be mobile (e.g., carried in a vehicle or by a person) or fixed (e.g., mounted on a wall or at the opener 120). The remote actuator 160 is an example of the actuator 50 of FIG. 1, and may in some cases be a smartphone or other computing device of the user. The remote actuator 160 may be located in a vehicle, or may be carried by the user, or otherwise be movable and usable when within range of the opener 120 to wirelessly instruct the opener 120 to operate to open or close the sectional door 110. The remote actuator 160 may include a simple button or other actuation element to operate the opener 120. However, in other examples, the remote actuator 160 may include a display (e.g., touch screen display) or other more complicated user interface to enable control of the opener 120 in addition to other functions associated with operation, monitoring or control of the GDO system 100.

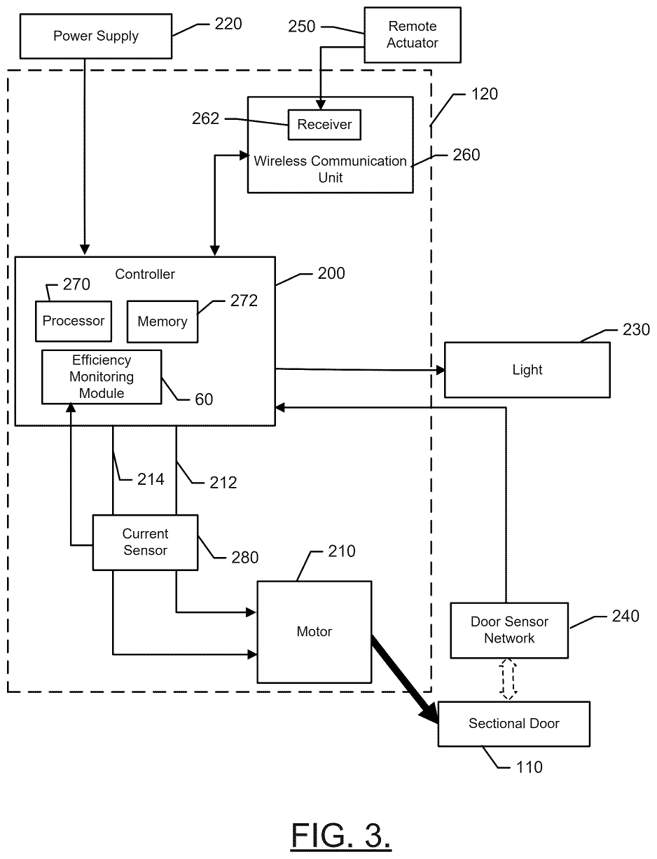

Turning to FIG. 3, a block diagram of various components of the GDO system 100 of an example embodiment is shown. In particular, various internal components of the opener 120 of FIG. 2 are shown. In particular, the opener 120 may include a controller 200 (e.g., an example of controller 40 from FIG. 1) and a motor 210 (e.g., an example of the motor/operator 20 of FIG. 1). The motor 210 may operate under control of the controller 200, which may receive power from a power supply 220 (e.g., mains power), and may regulate the provision of power to the motor 210 to control both the operation of the motor 210 and the direction of the operation (e.g., closing or opening). In some cases, the controller 200 may provide separate power for forward (e.g., closing) and reverse (e.g., opening) directions of operation, and such power may be provided as a forward power connection 212 (for forward direction motor windings) and a reverse power connection 214 (for reverse direction motor windings). The controller 200 may also selectively provide power to a light 230 whenever the motor 210 operates (and for some period thereafter, or when otherwise turned on via the controller 200).

In an example embodiment, a door sensor network 240 may be disposed on or proximate to the sectional door 110 to monitor aspects of the movement of the sectional door 110 and/or its environment. The door sensor network 240 may include motion, speed, force and other sensors associated with movement of the sectional door 110 including, for example, limit switches that determine respective limits for motion of the sectional door 110 in both the opening and closing directions. Moreover, the door sensor network 240 may also include an obstruction sensor, which may detect when an object is between the sectional door 110 and the ground beneath the sectional door 110 to ensure that the sectional door 110 does not close on the object. In some cases, the obstruction sensor may include an infrared or other beam emitter, and a corresponding beam receiver that provides an input to the controller 200 to indicate that the beam emitted by the beam emitter is not being received at the beam receiver (e.g. due to the object, or misalignment of the emitter and receiver). When the controller 200 receives the input from the obstruction sensor, the controller 200 stops provision of power to the motor 210 to stop movement of the motor 210. Similarly, when the limit switches are triggered, the controller 200 is informed and stops movement of the motor 210, which in most cases simply means stopping the provision of power via both the forward and reverse power connections 212 and 214.

In an example embodiment, the controller 200 may be operable responsive to input from a mobile or fixed remote actuator 250 (often simply called a “remote”, and an example of the remote actuator 160 of FIG. 2). In some cases, the remote actuator 250 may be directly or hard wired to the controller 200 and may, for example, be a button, panel or display located on a wall that is convenient for the user to access for operation of the opener 120 inside the garage or other space being enclosed via the sectional door 110. However, particularly for the mobile instances of the remote actuator 250, a wireless communication unit 260 may be included in the opener 120 to receive wireless transmissions from the remote actuator 250 to trigger operation of the controller 200 and consequently also the motor 210. The wireless communication unit 260 may, in some cases, include a receiver 262 that is capable of receiving transmissions from the remote actuator 250 for triggering operation of the controller 200.

The controller 200 may, in some cases, include processing circuitry that is configured to control the operation of the controller 200. In this regard, for example, the processing circuitry may include a processor 270 and memory 272. The memory 272 may store data, applications (e.g., for execution by the processor 270) or any other suitable information for local or remote usage consistent with the descriptions provided herein. In some cases, the processing circuitry may be part of a printed circuit board (PCB), application specific integrated circuit (ASIC) or other integrated circuit (IC) chip, board or the like. The processing circuitry may therefore, depending on its configuration (e.g., via hardware, firmware and/or software) enable the controller 200 to execute coordinated control over the motor 210 and various other accessories of the GDO system 100 including, potentially, an ability to measure efficiency of the motor 210 to perform efficiency analysis as described herein.

In order to incorporate the controller 200 into motor efficiency determinations, the controller 200 may be operably coupled to one or more additional sensors that specifically monitors a parameter that changes in such a way as to indicate that either maintenance is due, or that some other condition of note exists (e.g., the motor 210 having insufficient power to physically move the sectional door 110 efficiently). As noted above, current draw by the motor 210 may be one such parameter. Thus, in an example embodiment, the opener 120 may further include a current sensor 280 that may monitor current drawn by the motor 210. In some examples, the current sensor 280 may passively monitor both the forward and reverse power connections 212 and 214 by inductively measuring magnetic fluctuations in the forward and reverse power connections 212 and 214, and inferring current values based on the magnetic fluctuations. However, in other examples, the current sensor 280 may be wired into the circuit of the forward and reverse power connections 212 and 214 to measure current draw. Any other suitable options for operable coupling of the current sensor 280 to the motor 210 in such a way that permits measurement of current draw thereby are also possible. The current sensor 280 may, in some cases, provide current draw data measured during a door operation cycle (e.g., opening or closing) to the controller 200, and the controller 200 may store the current draw data and/or input voltage data in the memory 272.

The current measurements made by the current sensor 280 (i.e., the current draw data) may be provided (directly or indirectly) to the efficiency monitoring module 60, which may be located at the controller 200 (or at least at the opener 120) in some cases. The efficiency monitoring module 60 may be configured to monitor the current draw by the motor 210 in order to determine an efficiency of the motor 210 as described in greater detail below. In some embodiments, the efficiency monitoring module 60 may be instantiated as an application stored in the memory 272 and executable by the processor 270. However, in other cases, the efficiency monitoring module 60 may have its own processing circuitry and, in still other embodiments, the efficiency monitoring module 60 may be located separately from the controller 200. In any case, the current draw data may be processed by the efficiency monitoring module 60 as described herein to determine efficiency of the motor 210 and, when the efficiency is at a level that dictates doing so, to send the notification 70. The notification 70 may, in some cases, be an alarm or other indication (visual, audible, or electronic message) to the user to indicate as much. Thus, for example, the controller 200 may cause the light 230 to flash with a given pattern that is associated with indicating that the efficiency calculated is below expectations, and that some action may be taken. Moreover, in some cases, the pattern of flash may indicate the nature of the fault or condition causing the low efficiency. However, a display at the controller 200 (or the efficiency monitoring module 60) could alternatively indicate the condition as well.

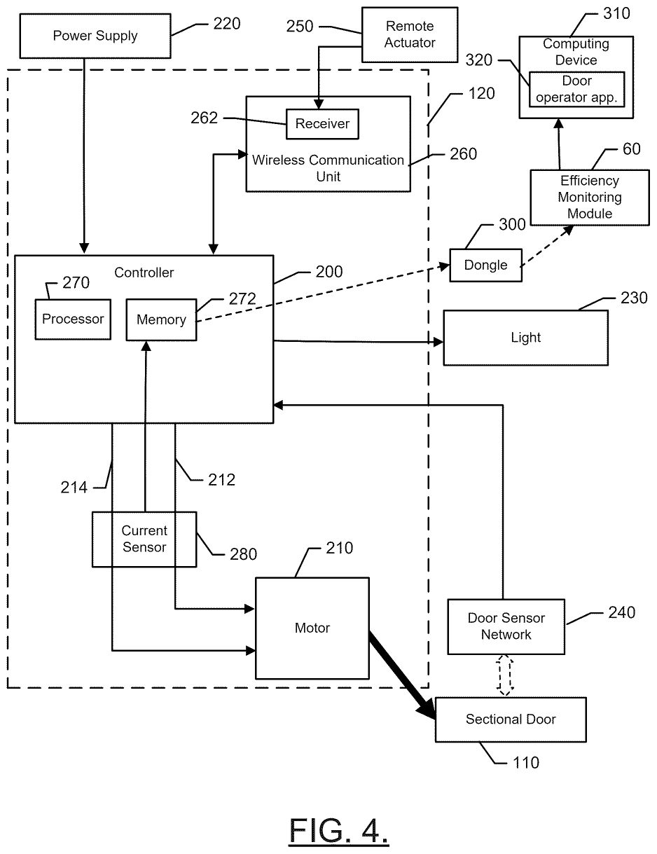

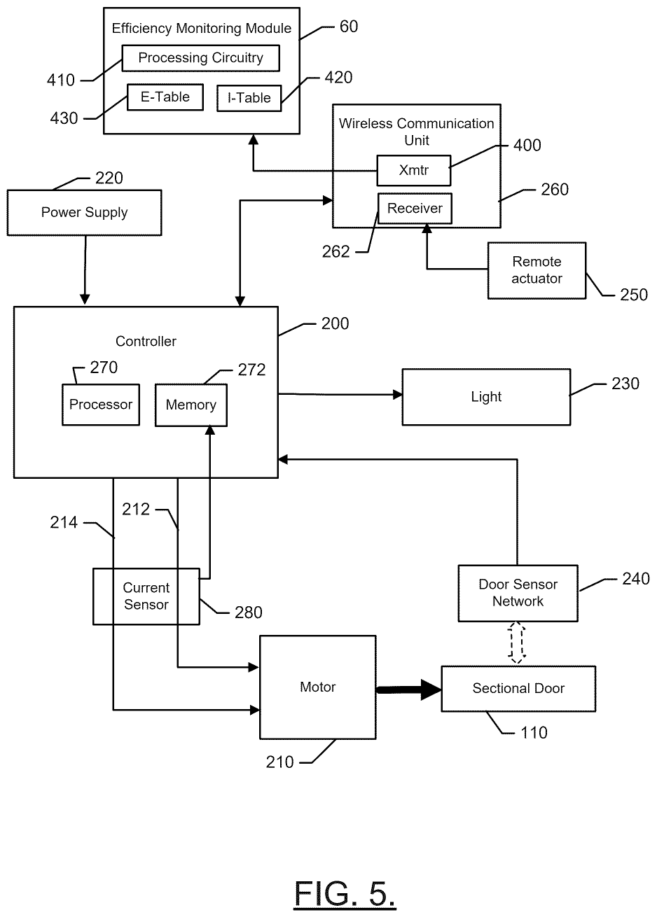

Before discussing specific examples of how the efficiency monitoring module 60 measures and processes information to determine efficiency information, and to act upon the determinations made, some other architectures and locations for the efficiency monitoring module 60 will be discussed in reference to FIGS. 4 and 5. In this regard, FIG. 4 illustrates an example in which the current draw data is provided from the current sensor 280 directly to the memory 272. A dongle 300, thumb drive or other removable memory may then be used as a transfer device to upload the current draw data from the memory 272 and then download the current draw data to the efficiency monitoring module 60, which may be located remotely from the opener 120. An operator (e.g., maintenance personnel) may install the dongle 300 into the opener 120 to communicate with the memory 272 and then do the same with the efficiency monitoring module 60 at its remote location. In this regard, the efficiency monitoring module 60 may be located at computer of the user, a maintenance entity, or the manufacturer, for example. However, the dongle 300 is just one example tool for transferring data. In other cases, the opener 120 may generate a QR code or other readable code that includes the current draw data, and after receiving the readable code, a reading device may transmit the code or information to the efficiency monitoring module 60. The reader may be operated by a maintenance technician in some cases.

The processing circuitry used to perform the processing of the efficiency monitoring module 60 may therefore include a processor and memory that are located at the respective server or other computing device (including a smart phone or tablet) of the user, maintenance entity or manufacturer. An alert, message or alarm may then be provided at the computing device as an example of the notification 70. However, if the computing device is not the user's, in some cases, the efficiency monitoring module 60 may provide a message as the notification 70 to a computing device 310 of the user to indicate the condition. Moreover, a door operator application 320 on the computing device 310 may provide options for interacting with the message including making a service call to maintenance personnel. In such cases, the notification 70 may be the service call.

FIG. 5 illustrates still another example in which the efficiency monitoring module 60 is remotely located with respect to the controller 200. However, in the example of FIG. 5, the wireless communication unit 260 may further include a transmitter 400 that can transmit the current draw data to the efficiency monitoring module 60. If the efficiency monitoring module 60 is located at the home of the user (e.g., on the user's home computer, tablet or smart phone), the transmitter 400 may use WiFi, Bluetooth©, or other short range wireless communication protocols to send the current draw data to the efficiency monitoring module 60. However, if the efficiency monitoring module 60 is located at a maintenance facility more remote, 5G or other long range wireless communication protocols may be used. The efficiency monitoring module 60 may then provide messages or alerts as the notification 70 as discussed above in reference to FIG. 4 based on the efficiency determination made as discussed in greater detail below.

In this regard, the current draw data that is measured by the current sensor 280 may be compared to reference current data to determine an efficiency rating. For example, the reference current data may represent a normal, acceptable, or highly efficient current draw for the motor 210. The reference current data may be obtained from factory testing, or even from actual performance data associated with the motor 210 of other motors having a similar device class (e.g., sharing a similar model number, type indicator, power rating, etc.). As the motor 210 cycles over time, its efficiency may be expected to be reduced as springs wear, and friction builds up in various components, or components age, etc. Thus, the efficiency rating may be expected to reduce over time. A further comparison of the efficiency rating that is determined at any given time to a threshold that may be set for the device class may then be used as a potential trigger for sending the notification 70.

Although the general concept of this comparison may be relatively straightforward, it should be appreciated that given the number of cycles of opening and closing that may occur in a given period of time, the amount of data that may ultimately be generated may become cumbersome to process, communicate and/or store. Moreover, it may also be the case that it is not necessary to run comparisons over the full scope of measured data, but instead comparisons may be strategically limited to particular portions of the measured data that are most likely to be informative in relation to the condition being detected. Accordingly, data may in some cases only be processed for particular phases or even event stages within the particular phases. The focus on a smaller section of data may further mean that in some cases, less data needs to be recorded and stored, communicated and processed.

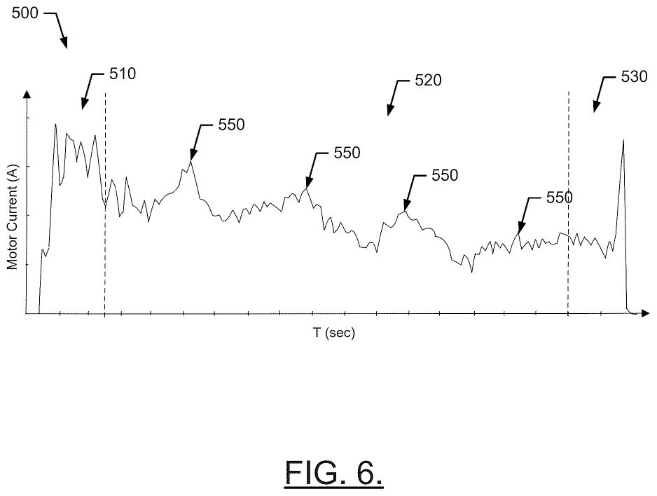

FIG. 6 illustrates an example plot 500 of received current draw data according to an example embodiment. The plot 500 shows current draw versus time for an opening cycle of the sectional door 110. The plot 500 is broken into three phases including a kickoff phase 510, a running phase 520 and a slowdown phase 530. For the opening cycle, the kickoff phase 510 typically involves a large current draw since the full weight of the sectional door 110 is being lifted off the floor. Since the movement of the sectional door 110 in the kickoff phase 510 is largely happening in a vertical section of the rails 114, there may not be much change in the current draw from one cycle to the next, even if measured over a long period of time. Thus, the kickoff phase 510 may not be a good phase to use for measuring efficiency. Likewise, in the slowdown phase 530 of the opening cycle, the sectional door 110 is mostly lying in a horizontal plane getting closer to the opener 120 and slowing down as the limit of motion is approached. Thus, the weight of the sectional door 110 is almost all being borne by the horizontal sections of the rails 114 with little change either in one cycle or across different cycles.

However, during the running phase 520, each section of the sectional door 110 takes its turn transitioning through the portion of the rails 114 that bends from the vertical section thereof to the horizontal section thereof. These transitions occur when the hinges between sections change between the horizontal to the vertical sections, and there tends to be a small surge in current draw to complete the transition event. Each of these transition events (i.e., four of them for a four panel door) is its own even stage that could be considered to be a stage of interest 550, and current tends to reach a noticeable peak during the stages of interest 550. Accordingly, for the purposes of maximizing accuracy with the storage, communication and processing of as little data as possible, in some cases, the efficiency monitoring module 60 may perform the efficiency determinations on only data corresponding to the running phase 520, and may further focus on one or more of the event stages associated with each panel transitioning from horizontal to vertical sections of the rails 114. Thus, for example, only peak values may be stored, compared, or otherwise used for the efficiency calculations in some cases. Normal ranges of peak values for opening and closing cycles, and sometimes specifically for each hinge set and panel transition, may therefore be stored to determine when performance falls outside normal ranges.

The reference current data may therefore be gathered in consideration of (or in fact only for) certain phases. Thus, for example, the reference current data may include a weighted average of current draw data obtained from other motors or operators of the device class segmented by phase of a transition cycle of the movable barrier between the open position and the closed position. With respect to the weighting of data in the weighted average, at least one phase (e.g., the running phase 520) may have a higher weight applied than the other phases (e.g., the kickoff phase 510 and the slowdown phase 530). In an example embodiment, the reference current data may include a weighted average of current draw data obtained from the operator during a plurality of prior operation cycles segmented by phase of a transition cycle of the movable barrier between the open position and the closed position. Again, the running phase 520, or any particular phase, may be weighted higher than other phases.

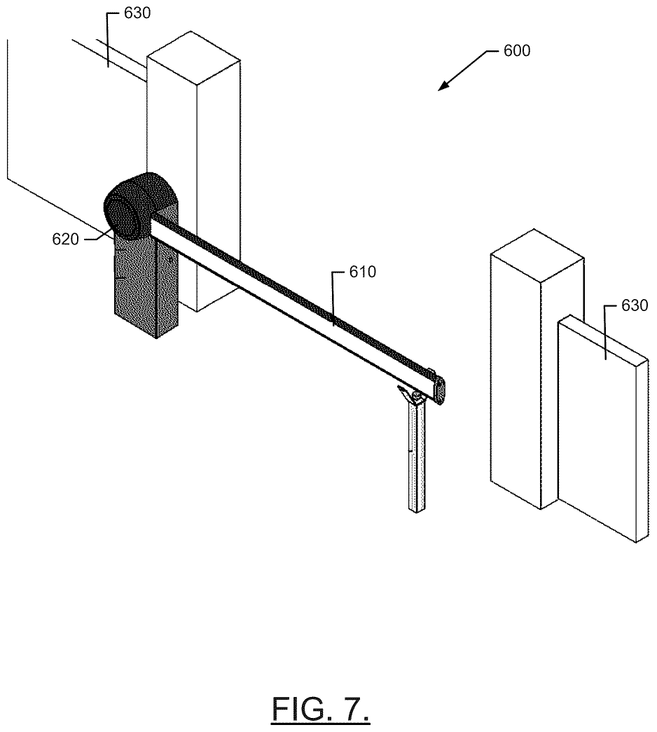

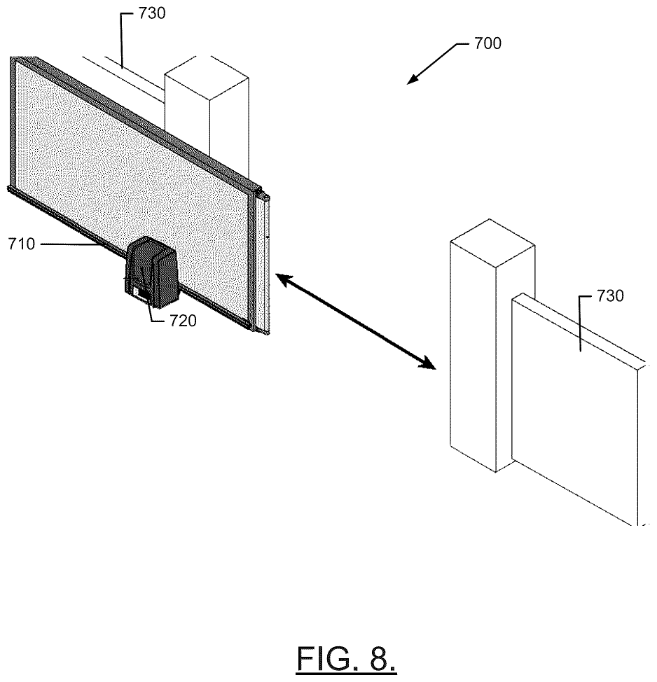

FIG. 6 illustrates a unique plot of current that is specific to a sectional door. However, similar unique plots of current may exist and be similarly handled for other types of movable barriers. FIGS. 7 and 8 illustrate two such different types of movable barriers. In this regard, FIG. 7 illustrates a lift gate 600 having a pivotable arm 610 as an example of the movable barrier 30 of FIG. 1. Opener 620 may include a motor that is operable to lift the pivotable arm 610 to open the lift gate 600 and permit access through an opening formed in a fence, wall or other enclosure 630. When not lifted, the pivotable arm 610 is in the closed position, which is shown in FIG. 7.

Turning to FIG. 8, a sliding gate 700 is shown. The sliding gate 700 includes a slidable gate 710 as an example of the movable barrier 30 of FIG. 1. Opener 720 may include a motor that is operable to translate or slide the slidable gate 710 away from an opening in a fence, wall or other enclosure 730 to open the sliding gate 700 and permit access through the opening. When not lifted, the slidable gate 710 is disposed opening and therefore in the closed position, which is shown in FIG. 8. In both FIGS. 7 and 8, the motor current draw may be monitored by an instance of the efficiency monitoring module 60 to make efficiency determinations and also determine whether the efficiency measured warrants any further action (e.g., sending the notification 70).

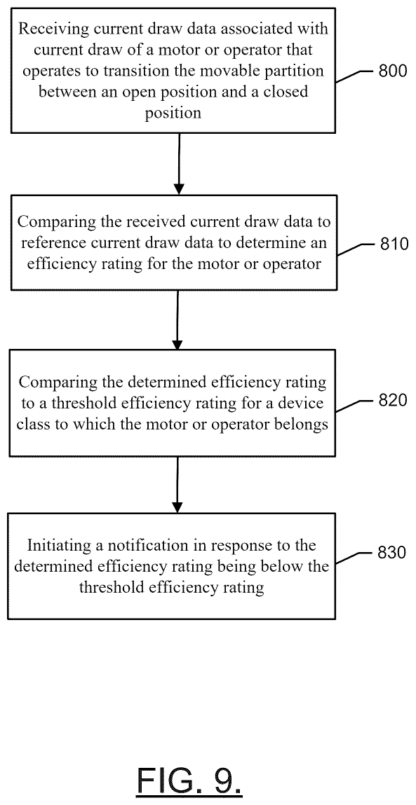

FIG. 9 illustrates a method of evaluating performance of an opener of a movable barrier in an automated operating system in accordance with an example embodiment. In this regard, the method may include receiving current draw data associated with current draw of an operator that operates to transition the movable barrier between an open position and a closed position at operation 800. The method may further include comparing the received current draw data to reference current draw data to determine an efficiency rating for the operator at operation 810, comparing the determined efficiency rating to a threshold efficiency rating for a device class to which the operator belongs at operation 820, and initiating a notification in response to the determined efficiency rating being below the threshold efficiency rating at operation 830. The device class (e.g., power rating, model, type, etc.) may be known inherently based on the communication protocol employed for reporting data and performing calculations in some cases. However, in other cases, the device class may be provided by the user or other individual at the time of system setup or installation. For example, registration data for registering the product for warranty purposes may require entry of the model number, which may in turn provide the device class. Other method may also be used.

In some cases, only certain device classes may be suitable for usage with respective different movable barriers. For example, the weight of the movable barrier 30 may dictate which device class is suitable for use with that amount of weight for efficient operation. Thus, in some cases, the registration data may include an estimated weight of the movable barrier. In an example embodiment, a table (or tables) may be provided (e.g., at the efficiency monitoring module 60 or processing circuitry 410 (e.g., processor and memory) associated therewith) to obtain certain information that may be used (again by the processing circuitry 410 for efficiency calculations and actions associated therewith. For example, reference current data may be obtained from a table (e.g., I-Table 420). In some cases, the reference current data in the table may be organized by weight of the movable barrier 30, by device class, age, or any other suitable organizational method. Similarly, even after calculating the efficiency rating at operation 810, the threshold to which the efficiency rating is to be compared may also be obtained from a table (e.g., E-Table 430). The efficiency table may also be organized by weight of the movable barrier 30, by device class, age, or any other suitable organizational method.

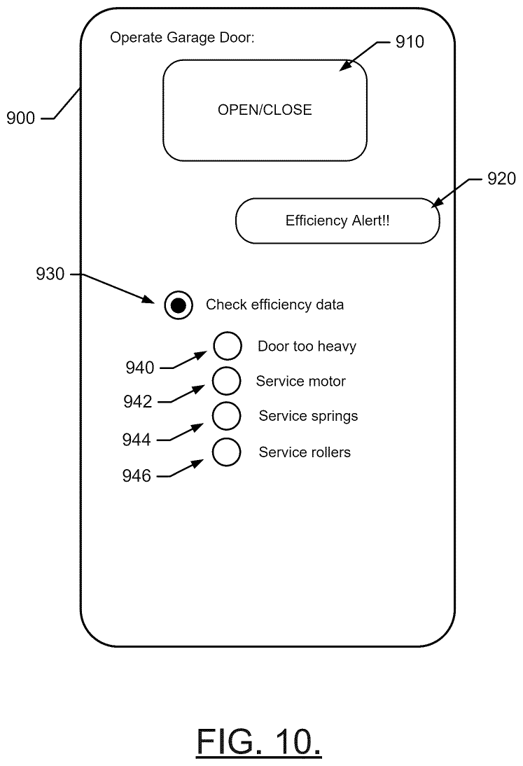

As noted above, when the efficiency measured is poor, indicates a power mismatch for the weight of the movable barrier 30, or otherwise unacceptable, various means of notifying the user may be employed. One such means may be to provide the notification 70 to the user on a computer or smart phone application via which various aspects of the operation of the opener 120 or the system in general may be managed. FIG. 10 illustrates one example of an interface screen 900 that may be used as part of a control console or web page for a remote computer/application. Of note, although the interface screen 900 of FIG. 10 shows an open/close button 910 on the same screen or page as a notification 920 and various other options for adjusting settings for the system, these separate functions and buttons may alternatively be provided on separate pages or screens.

In response to receipt of the notification 920, the user may check system settings, which may include an option to check efficiency data 930 (among other control options). When the check efficiency data 930 option is selected, various other options or indications may be presented including, for example, a door to heavy indication 940, a service motor indication 942, a service spring indication 944, or a service rollers indication 946. In some cases selection of any of the indications may provide data or other information to indicate the reason why the corresponding service is required. A service call request may also be initiated in some cases. The service call request, or perhaps another separate option may, in some cases, cause the data to be provided to the service technician or maintenance facility. The user may also or alternatively have a setting that provides a continuous reporting of current draw data to the service technician or maintenance facility and such data may be stored locally for analysis and building of the predictive models noted above. Other options and interactions may also be possible in other example embodiments. And it can be appreciated that the example of FIG. 10 also applies specifically to an example in which the movable barrier 30 is embodied as the sectional door 110 of FIG. 2. Thus, the notifications and indications may be tailored to the specific type of door or gate employed in each respective embodiment.

Accordingly, some example embodiments may provide a system for automated operation of a movable barrier. The system may include a controller, an operator operable under control of the controller where the operator is operably coupled to the movable barrier to transition the movable barrier between an open position and a closed position responsive to operation of the operator, and an efficiency monitoring module. The efficiency monitoring module may include processing circuitry configured to perform the method described above in reference to FIG. 9. In this regard, the processing circuitry may be configured to receive current draw data associated with current draw of the operator while transitioning the movable barrier between the open position and the closed position, compare the received current draw data to reference current draw data to determine an efficiency rating for the operator, compare the determined efficiency rating to a threshold efficiency rating for a device class to which the operator belongs, and initiate a notification in response to the determined efficiency rating being below the threshold efficiency rating.

The module, method executed by the module, and/or a system including the same, or components thereof described above may be augmented or modified by altering individual features mentioned above or adding optional features. The augmentations or modifications, or any optional features, may be combined in any combination including any of all of the features listed below. In this regard, for example, the method may include an initial operation of receiving registration data for the operator. The registration data may define the device class and provide an estimated weight of the movable barrier. In an example embodiment, the reference current draw data may be obtained from a first table associating weight specific current draw data to a corresponding different weights of movable barriers. In some cases, the threshold efficiency rating may be obtained from a second table associating efficiency thresholds to respective different weights of the movable barriers. In an example embodiment, the notification may include a notification comprises an indication that the device class to which the operator belongs is insufficient to operate the movable barrier based on the estimated weight of the movable barrier. In some cases, the reference current draw may include a weighted average of current draw data obtained from other motors or operators of the device class segmented by phase of a transition cycle of the movable barrier between the open position and the closed position, with at least one phase having a higher weight applied than at least one other phase. In an example embodiment, the reference current draw may include a weighted average of current draw data obtained from the operator during a plurality of prior operation cycles segmented by phase of a transition cycle of the movable barrier between the open position and the closed position, with at least one phase having a higher weight applied than at least one other phase. In some cases, the reference current draw may include a weighted average of current draw data, and the weighted average may include current data segmented by phase of a transition cycle of the movable barrier between the open position and the closed position, with a running phase having a higher weight applied than a kickoff phase and a slowdown phase. In an example embodiment, the notification may provide an identification of a component due for maintenance or an indication that the operator is insufficient to operate the movable barrier. In some cases, the notification may be transmitted wirelessly to a computing device of a user, and the notification is selectable on an interface console of an application associated with operation of the movable barrier to review detailed information regarding a reason for generation of the notification.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A system for automated operation of a movable barrier, the system comprising:
a controller;
an operator operable under control of the controller, the operator being operably coupled to the movable barrier to transition the movable barrier between an open position and a closed position responsive to operation of the operator; and
an efficiency monitoring module comprising processing circuitry configured to:
receive current draw data associated with current draw of the operator while transitioning the movable barrier between the open position and the closed position;
compare the received current draw data to reference current draw data to determine an efficiency rating for the operator;
compare the determined efficiency rating to a threshold efficiency rating for a device class to which the operator belongs; and
initiate a notification in response to the determined efficiency rating being below the threshold efficiency rating.

2. The system of claim 1, wherein the processing circuitry is further configured to perform an initial operation of receiving registration data for the operator, and
wherein the registration data defines the device class and provides an estimated weight of the movable barrier.

3. The system of claim 2, wherein the reference current draw data is obtained from a first table associating weight specific current draw data to a corresponding different weights of movable barriers.

4. The system of claim 3, wherein the threshold efficiency rating is obtained from a second table associating efficiency thresholds to respective different weights of the movable barriers.

5. The system of claim 2, wherein the notification comprises an indication that the device class to which the operator belongs is insufficient to operate the movable barrier based on the estimated weight of the movable barrier.

6. The system of claim 1, wherein the reference current draw comprises a weighted average of current draw data obtained from other motors or operators of the device class segmented by phase of a transition cycle of the movable barrier between the open position and the closed position, with at least one phase having a higher weight applied than at least one other phase.

7. The system of claim 1, wherein the reference current draw comprises a weighted average of current draw data obtained from the operator during a plurality of prior operation cycles segmented by phase of a transition cycle of the movable barrier between the open position and the closed position, with at least one phase having a higher weight applied than at least one other phase.

8. The system of claim 1, wherein the reference current draw comprises a weighted average of current draw data; and
wherein the weighted average comprises current data segmented by phase of a transition cycle of the movable barrier between the open position and the closed position, with a running phase having a higher weight applied than a kickoff phase and a slowdown phase.

9. The system of claim 1, wherein the notification provides an identification of a component due for maintenance or an indication that the operator is insufficient to operate the movable barrier.

10. The system of claim 1, wherein the notification is transmitted wirelessly to a computing device of a user, and wherein the notification is selectable on an interface console of an application associated with operation of the movable barrier to review detailed information regarding a reason for generation of the notification.

11. A method of evaluating performance of an opener of a movable barrier in an automated operating system, the method comprising:
receiving current draw data associated with current draw of an operator that operates to transition the movable barrier between an open position and a closed position;
comparing the received current draw data to reference current draw data to determine an efficiency rating for the operator;
comparing the determined efficiency rating to a threshold efficiency rating for a device class to which the operator belongs; and
initiating a notification in response to the determined efficiency rating being below the threshold efficiency rating.

12. The method of claim 11, further comprising an initial operation of receiving registration data for the operator,
wherein the registration data defines the device class and provides an estimated weight of the movable barrier.

13. The method of claim 12, wherein the reference current draw data is obtained from a first table associating weight specific current draw data to a corresponding different weights of movable barriers.

14. The method of claim 13, wherein the threshold efficiency rating is obtained from a second table associating efficiency thresholds to respective different weights of the movable barriers.

15. The method of claim 12, wherein the notification comprises an indication that the device class to which the operator belongs is insufficient to operate the movable barrier based on the estimated weight of the movable barrier.

16. The method of claim 11, wherein the reference current draw comprises a weighted average of current draw data obtained from other motors or operators of the device class segmented by phase of a transition cycle of the movable barrier between the open position and the closed position, with at least one phase having a higher weight applied than at least one other phase.

17. The method of claim 11, wherein the reference current draw comprises a weighted average of current draw data obtained from the operator during a plurality of prior operation cycles segmented by phase of a transition cycle of the movable barrier between the open position and the closed position, with at least one phase having a higher weight applied than at least one other phase.

18. The method of claim 11, wherein the reference current draw comprises a weighted average of current draw data; and
wherein the weighted average comprises current data segmented by phase of a transition cycle of the movable barrier between the open position and the closed position, with a running phase having a higher weight applied than a kickoff phase and a slowdown phase.

19. The method of claim 11, wherein the notification provides an identification of a component due for maintenance or an indication that the operator is insufficient to operate the movable barrier.

20. The method of claim 11, wherein the notification is transmitted wirelessly to a computing device of a user, and wherein the notification is selectable on an interface console of an application associated with operation of the movable barrier to review detailed information regarding a reason for generation of the notification.
